(19) United States
(12) Patent Application Publication
(10) Pub. No.: US 2011/0227521 A1
(43) Pub. Date: Sep. 22, 2011

(54) METHOD OF STARTING A FAN

(75) Inventors: Shao-Feng Lu, Taoyuan County (TW); Chih-Chang Tsai, Taoyuan County (TW)

(73) Assignees: FSP TECHNOLOGY INC., Taoyuan County (TW); 3Y POWER TECHNOLOGY (TAIWAN), INC., Taoyuan County (TW)

(21) Appl. No.: 12/728,282

(22) Filed: Mar. 22, 2010

(51) Int. Cl. H02H 7/085; H02P 1/04; H02H 3/04

(52) U.S. Cl. 318/400.21; 318/431; 318/490

(57) ABSTRACT

A fan starting method including following steps is provided. A fan module including a control unit and a fan is provided, wherein the control unit and the fan are electrically connected with each other. An electric power is supplied to the fan module, wherein the electric power drives the fan to rotate at a full speed. Whether the fan rotates is determined by the control unit within a predetermined time. If the fan rotates, the fan is controlled to rotate at a predetermined load speed after the predetermined time. If the fan does not rotate, an alarm signal or an off signal is issued by the control unit.

### BACKGROUND OF THE INVENTION

1. Field of the Invention

The present invention generally relates to a fan starting method, and more particularly, to a fan starting method that can effectively prevent other components in a system using a fan module from being damaged by overheating.

2. Description of Related Art

Computer system is one of the most important hardware equipments in today's information technology. Along with the increase in the operation speed of a computer system, much heat is produced by circuits (especially the central processing unit—CPU) within the computer system when these circuits are in operation. The heat should to be efficiently dissipated in order to maintain the stability and constant operation of the computer system. A fan module is usually disposed in a computer system, and which effectively dissipates the heat produced in the computer system so as to reduce the temperature of components in the computer system, such as the CPU and the display card.

However, along with the use of the fan module, dirt may be accumulated at where the leaves of the fan and the bearing are assembled, or the lubricant between the leaves of the fan and the bearing may dry up. When a power source supplies an electric power to the fan so as to drive the fan to rotate, the fan may not rotate smoothly due to the accumulated dirt or lack of lubrication, and accordingly noises may be made, the rotation speed may be reduced, and the entire fan module may get very hot. The entire fan module may even be damaged when the fan completely stops rotating and accordingly the resistance increases.

### SUMMARY OF THE INVENTION

Accordingly, the present invention is directed to a fan starting method that can prevent other components in a system using a fan module from being damaged by overheating when a fan of the fan module does not rotate initially.

The present invention provides a fan starting method including at least the following steps. A fan module including a control unit and a fan is provided, wherein the control unit and the fan are electrically connected with each other. An electric power is supplied to the fan module, and the electric power drives the fan to rotate at a full speed. Whether the fan rotates is determined by the control unit within a predetermined time. If the fan rotates, the fan is controlled to rotate at a predetermined load speed after the predetermined time. If the fan does not rotate, an alarm signal or an off signal is issued by the control unit.

In the fan starting method according to an embodiment of the present invention, the fan module further includes a sensor, used for detecting whether the fan rotates and sending a detecting signal back to the control unit, wherein the sensor is a current sensor or a resistance sensor.

In the fan starting method according to an embodiment of the present invention, the full speed of the fan is greater than the predetermined load speed of the fan.

In the fan starting method according to an embodiment of the present invention, the control unit issues the off signal to cut off the electric power supplied to the fan, and a system using the fan module is further shut down after the electric power supplied to the fan is cut off.

In the fan starting method according to an embodiment of the present invention, the control unit issues the alarm signal to remind a user to cut off the electric power supplied to the fan, and a system using the fan module is further shut down after the user cuts off the electric power supplied to the fan.

As described above, in the fan starting method provided by the present invention, whether the fan rotates is first detected, and then determining whether the fan is controlled to rotate at the predetermined load speed or the power supply of the fan is cut off, so that other components in the system using the fan module are prevented from being damaged by overheating.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a fan module according to an embodiment of the present invention.

FIG. 2 is a flowchart of a fan starting method of the fan module in FIG. 1.

FIG. 3 illustrates the variation of the rotation speed of a fan with time.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

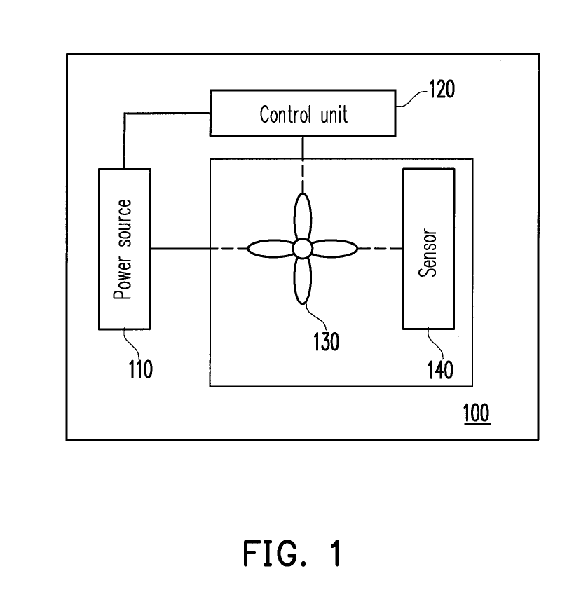

FIG. 1 is a circuit diagram of a fan module according to an embodiment of the present invention. Referring to FIG. 1, the fan module 100 includes a control unit 120 and a fan 130, wherein the control unit 120 and the fan 130 are electrically connected with each other. Besides, the fan module 100 further includes a sensor 140. The sensor 140 may be a current sensor or a resistance sensor, and the disposition of the sensor 140 is determined according to the actual requirement. Generally speaking, the sensor 140 is built in the fan 130. However, the sensor 140 may also be disposed on other components of the fan module 100 according to the actual requirement.

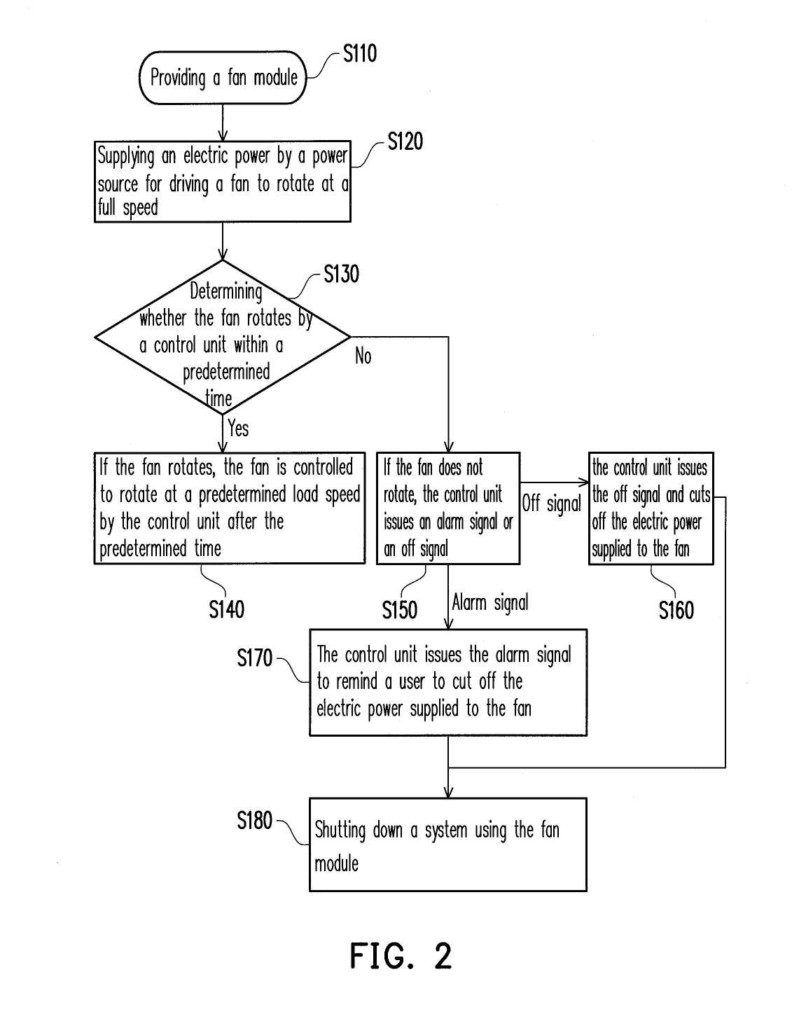

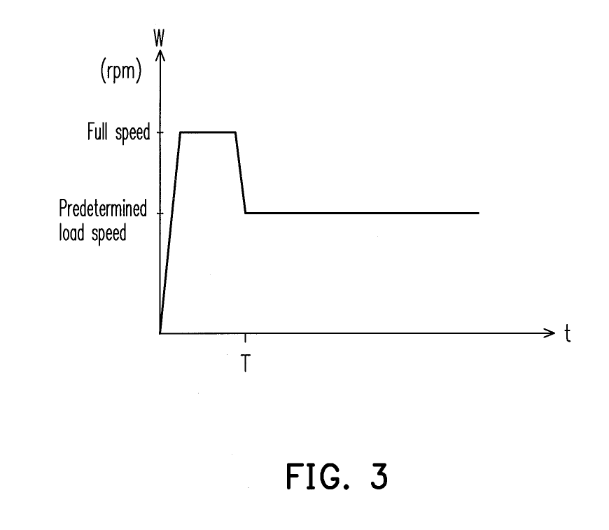

FIG. 2 is a flowchart of a fan starting method of the fan module 100 in FIG. 1, and FIG. 3 illustrates the variation of the rotation speed of the fan 130 with time. Referring to FIG. 1, FIG. 2, and FIG. 3, the fan starting method includes at least the following steps. In step S110, the above mentioned fan module 100 is provided. Then, in step S120, a power source 110 is provided. The power source 110 supplies an electric power to the fan module 100, and the electric power is sufficient for driving the fan 130 to rotate at a full speed when the power source 110 just starts to supply the electric power.

Then, in step S130, the control unit 120 determines whether the fan 130 rotates within a predetermined time T, wherein the predetermined time T is determined according to user's requirement. Next, in step S140, if the fan 130 rotates, the control unit 120 controls the fan 130 to rotate at a predetermined load speed after the predetermined time T, wherein the full speed is greater than the predetermined load speed. Or as in step S150, if the fan 130 does not rotate, the control unit 120 issues an alarm signal or an off signal. Taking the off signal as an example, in step S160, the control unit 120 issues the off signal to cut off the electric power supplied by the power source 110 to the fan 130.

To be specific, the sensor 140 detects whether the fan 130 rotates and sends a detecting signal back to the control unit 120. Different sensing technique is adopted along with the different type of the sensor 140. Taking a current sensor as an example, the current sensor is usually built in the fan 130, and based on the relational expression V=IR of voltage, current, and resistance (wherein V represents voltage, I represents current, and R represents resistance), the fan 130 is determined to be rotating if a current value is obtained and the current value is about a constant value within the predetermined time T. Accordingly, the fan 130 then is controlled to rotate at the predetermined load speed in step S140. Otherwise, the fan 130 is determined to be not rotating if no current value is detected or the current value is about zero within the predetermined time T. Accordingly, the electric power supplied by the power source 110 to the fan 130 is then cut off in step S160.

To be more specific, the power source 110 supplies a fixed voltage to the fan 130 such that the fan 130 can rotate at the full speed as expected. If the fan 130 still does not rotate even an electric power sufficient for driving the fan 130 to rotate at the full speed is supplied, it may be that there is too much dirt accumulated in the fan 130 or the lubricant within the bearing dries up and accordingly the friction thereof increases, etc. All these situations may result in the increase of the circuit load. In other words, the resistance is infinite and the current is almost zero (i.e., the current sensor cannot detect any current value or detects an extremely small current value). In this case, if the power source 110 keeps supplying the electric power to the fan 130, the temperature inside the circuit increases and accordingly the circuit is damaged. As a result, the entire fan module 100 is destroyed. Thus, when the current sensor detects that the fan 130 does not rotate within the predetermined time T, the current sensor sends a detecting signal back to the control unit 120, and the control unit 120 then cuts off the power supply of the power source 110 in step S160 so as to ensure that the fan module 100 won't be damaged by overheating.

In other embodiments, those skilled in the art may also use an optical sensor for detecting whether the fan 130 rotates. The optical sensor may be disposed corresponding to the fan 130 on another component in the fan module 100. When the power source 110 supplies the electric power to the fan 130 in step S120, if the fan 130 rotates, the optical sensor intermittently receives light, so that the control unit 120 receives a detecting signal indicating that the fan 130 is rotating. Next, in step S140, the control unit 120 controls the fan 130 to rotate at the predetermined load speed after the predetermined time T. If the optical sensor constantly receives the light or does not receive any light within the predetermined time T, the control unit 120 receives a detecting signal indicating that the fan 130 does not rotate. In this case, in step S160, the control unit 120 cuts off the electric power supplied by the power source 110 to the fan 130 after the predetermined time T.

Thereafter, in step S180, after the control unit 120 issues the off signal to cut off the electric power supplied by the power source 110 to the fan 130, the control unit 120 further shuts down the system using the fan module 100.

Referring to FIG. 1 and FIG. 2 again, taking the alarm signal as an example, in step S170, if the fan 130 does not rotate, the control unit 120 issues the alarm signal to notify the user to shut down the system using the fan module 100, wherein the alarm signal may be a flashing lamp, an alarm sound, or a text displayed in a display panel. Thereafter, in step S180, the system using the fan module 100 is shut down. In step S180, the system may be manually shut down by the user or automatically shut down when a control center thereof detects that the electric power supplied to the fan 130 is cut off. However, how the system is shut down is determined according to the actual requirement.

As described above, in the fan starting method provided by the present invention, an electric power sufficient for driving a fan to rotate at a full speed is supplied within a predetermined time, and whether the fan rotates is detected within the predetermined time. If the fan rotates, the fan is controlled to rotate at a predetermined load speed after the predetermined time. If the fan does not rotate, the power supply is cut off after the predetermined time. Thereby, components in the system using the fan module are prevented from being damaged by heat produced when the fan does not rotate, and accordingly the lifespan of the system using the fan module is prolonged.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A fan starting method, comprising:
providing a fan module, wherein the fan module comprises a control unit and a fan, and the control unit and the fan are electrically connected with each other;
supplying an electric power to the fan module, wherein the electric power drives the fan to rotate at a full speed;
determining whether the fan rotates within a predetermined time by using the control unit;
if the fan rotates, controlling the fan to rotate at a predetermined load speed after the predetermined time; and
if the fan does not rotate, issuing an alarm signal or an off signal by using the control unit.

2. The fan starting method according to claim 1, wherein the fan module further comprises a sensor, used for detecting whether the fan rotates and sending a detecting signal back to the control unit.

3. The fan starting method according to claim 2, wherein the sensor is a current sensor or a resistance sensor.

4. The fan starting method according to claim 1, wherein the full speed of the fan is greater than the predetermined load speed of the fan.

5. The fan starting method according to claim 1, wherein the control unit issues the off signal to cut off the electric power supplied to the fan.

6. The fan starting method according to claim 5 further comprising shutting down a system using the fan module after the electric power supplied to the fan is cut off.

7. The fan starting method according to claim 1, wherein the control unit issues the alarm signal to remind a user to cut off the electric power supplied to the fan.

8. The fan starting method according to claim 7 further comprising shutting down a system using the fan module after the user cuts off the electric power supplied to the fan.
